(19) United States
(12) Patent Application Publication
(10) Pub. No.: US 2025/0198436 A1
(43) Pub. Date: Jun. 19, 2025

(54) Spring clip for receiving a threaded nut in a torsion-proof manner, and threaded nut assembly and tensioning clamp comprising such a spring clip

(71) Applicant: NORMA GERMANY GMBH, Maintal (DE)

(72) Inventors: Fabio GHIRARDI, Hanau (DE); Detlef HENRICH, Limeshain (DE); Ahmed ALI, Newbury (GB)

(21) Appl. No.: 18/843,890

(22) PCT Filed: Jan. 16, 2023
(86) PCT No.: PCT/EP2023/050888

§ 371 Date: Sep. 4, 2024

(30) Foreign Application Priority Data
Mar. 4, 2022 (DE) 20 2022 101 207.5

(51) Int. Cl. F16B 2/24

(52) U.S. Cl. CPC F16B 2/243

(57) ABSTRACT

The disclosure relates to a spring clip for receiving a polygonal threaded nut in a torsion-proof manner, a corresponding threaded nut assembly, and a spring clamp having such a spring clip. The spring clip is substantially U-shaped and has a base and two limbs. Each limb has at least one step and a free end, one detent section being formed between the step and the free end of each limb. The free ends of the limbs are thereby bent away from each other.

### INTRODUCTION

The disclosure relates to a spring clip for receiving a polygonal threaded nut such that it cannot rotate. The disclosure also relates to a threaded nut arrangement comprising a spring clip of this type. Moreover, the disclosure relates to a tensioning clamp with a threaded nut arrangement comprising a spring clip of this type.

Threaded nuts arranged in spring clips are used, inter alia, to brace tensioning clamps. It is provided here that the threaded nut together with a tensioning screw is mounted in each case in front of a tensioning head of the clamp. Here, the spring clip or the cage serves, in particular, to arrange the threaded nut on the tensioning head, in order thus to facilitate the tensioning mechanism.

To this end, DE 10 2011 009 536 A1 has disclosed, for example, a spring clip for receiving a threaded nut such that it cannot rotate. The embodiment described therein is disadvantageous, however, because the threaded nut is already arranged in the spring clip while the latter is being formed. A subsequent introduction of the nut into the spring clip, that is to say after the spring clip has been formed into a cage, is not possible or is possible only with the use of further tools. A further disadvantage which results from the previously known solution consists in that each spring clip type can always interact with only a certain tensioning head type because the latching grooves of the spring clip cannot be adapted to clamp straps of different thickness without the use of further tools.

### SUMMARY

The disclosure, per an embodiment, is therefore based on an object of providing a spring clip for receiving a polygonal threaded nut, which eliminates the disadvantages in the prior art and which, in particular, facilitates the assembly of the threaded nut arrangement and which, moreover, simplifies the attachment of the threaded nut arrangement to the tensioning head provided to this end.

In order to achieve the object, according to an embodiment, a spring clip for receiving a polygonal threaded nut such that it cannot rotate is provided, the spring clip being of substantially U-shaped configuration and having a bottom and two limbs, each limb having at least one step and a free end, a latching portion being configured between the step and the free end of in each case one limb, and the free ends of the limbs being bent away from one another in each case. The spring clip is designed and constructed so that the bent free ends are at an exterior angle of more than 100° and, in particular, more than 120° relative to the latching portion.

It is possible in a simple way using a spring clip configured in this way for the spring clip and therefore the threaded nut arrangement to be introduced into a corresponding opening in the tensioning head of a tensioning clamp and to be latched to the tensioning clamp. Here, in particular, the free ends which are bent substantially to form a tip ensure that the limbs of the spring clips bend toward one another by way of a light exertion of force during the insertion of the spring clip into the opening. In other words: during the insertion of the spring clip into the opening of the tensioning head, the free ends of the limbs are pressed inward in the direction of the latching portions—the exterior angles α, α′ of the free ends can therefore become greater and the interior angles δ, δ′ of the free ends can become smaller. It is also possible, however, that the free ends which are bent to form tips transmit the inwardly acting (that is to say, in the direction of the passage) force to the limbs which, as a result, are bent inward instead of the free ends. In this case, the exterior angles α, α′ and the interior angles δ, δ′ of the free ends remain substantially constant. As a result, the maximum width of the spring clip is decreased, which results in it being possible for the spring clip to be pushed through a corresponding opening in the tensioning head. As soon as the free ends of the limbs have passed the opening, the limbs spring back into their starting state again. The free ends then prevent the spring clip from slipping out and therefore serve as a captive securing device.

The limbs therefore serve firstly to guide the spring clip through the corresponding opening of the tensioning head in the case of correct usage of the spring clip. Secondly, they serve with their portions which are configured substantially perpendicularly with respect to the bottom as a captive securing device of the polygonal threaded nut. Once it is arranged in the spring clip and between the limbs, the polygonal threaded nut can no longer rotate about its own center axis. High torques can be absorbed as a result.

As a result of the free ends of the limbs which are bent outwards, that is to say away from one another, it is possible, moreover, for the threaded nut to be introduced into the already formed spring clip. If they were bent inward (that is to say, in the direction of the center axis), an introduction of this type would not be possible. Therefore, the production of the threaded nut arrangement can be significantly facilitated because the step of forming the spring clip is no longer dependent on the presence of a threaded nut. Instead, the threaded nuts can be introduced through a passage into the receptacle provided to this end following the production of the spring clips. In this way, the spring clips according to at least one embodiment can be produced considerably more rapidly than previously.

It can be provided, moreover, that the latching portions of the limbs are of inclined configuration in each case with respect to a center axis which runs perpendicularly with respect to the bottom. It is provided here, in particular, that the latching portions are of inclined configuration with respect to the center axis A in such a way that a passage which is configured between the latching portions tapers in the direction of the bottom. An inclination or slope of the limbs or specifically of the latching portions of this type additionally contributes to it being possible for the threaded nuts to be introduced in a simple way into the receptacle of the spring clip after production of the spring clip. Finally, a configuration of this type of the limbs brings it about that the passage which is formed between the limbs runs at least in portions in a funnel-shaped manner in the direction of the bottom of the spring clip. As a result, the guidance of the threaded nut is facilitated.

It can advantageously also be provided, per an embodiment, that the limbs each comprise a first kink, a second kink and a third kink. Here, the first kink and the second kink configure the step of in each case one of the limbs, and the third kink is configured at the transition from the latching portion to the free end of in each case one of the limbs. As a result, the springing characteristic of the limbs is increased in comparison with limbs without a kink. Moreover, the kinks increase the stability of the limbs.

One advantageous refinement, per an embodiment, provides that a spacing B between the second kinks of the limbs is smaller than a spacing C between the third kinks of the limbs. The result of this embodiment is that the passage of the spring clip tapers in a funnel-shaped manner downward, that is to say in the direction of the first kink of the limbs. As a result, the introduction of the threaded nut into the spring clip is additionally facilitated. At the same time, the introduction of the spring clip into the opening of the tensioning head is also facilitated.

In accordance with one development, per an embodiment, the free ends can be bent away from one another in such a way that they are bent, kinked or folded in the region of the third kink and relative to the latching portion by an exterior angle of more than 90°, preferably of more than 100°, and, in particular, of more than 120°. Therefore, the limbs are configured as arrowheads in the region of the free. The result of this configuration is that the limbs can be introduced in a simple way into the corresponding opening of the tensioning clamp. As a result, moreover, the maximum width of the entire spring clip can be kept low. As a consequence, the spring clip can be guided with low effort into the corresponding opening of the tensioning head. A further advantage, per an embodiment, which results from acutely outwardly bent free ends consists in that, as a result, the force of the free ends on the edge surface of the opening of the tensioning head is increased because the free ends exert a spring force on the edge surface as a result of their downwardly (that is to say, in the direction of the bottom or in the direction of the edge surface of the tensioning head opening) directed prestress. As a consequence, the spring clip can be mounted or latched on the tensioning head with high reliability.

It can advantageously be provided, moreover, and per an embodiment, that the limbs comprise, in each case in the region of the latching portion, a latching groove which is configured to interact with an opening of a tensioning element. Here, the latching groove can interact with the inner edge of the opening of the tensioning element, with the result that the spring clip and therefore the threaded nut can be held captively on the tensioning element. Here, the latching groove can have such an extent that the spring clip can be latched pivotably to the tensioning element. It is advantageous here, per an embodiment, that the latching groove has a variable latching height E as a result of the acutely outwardly and downwardly bent free ends. Here, the latching height E is to be understood to mean the spacing between the free end and the first kink of in each case one limb. The free ends have a spring force as a result of their kinked configuration. It is made possible as a result that the latching groove can reliably grip tensioning heads with different material thicknesses. A spring clip with a latching groove of this type can thus be used, for example, with tensioning clamps, the clamp strap of which has a thickness of from 1 mm to 3 mm, preferably of from 1.5 mm to 2 mm. A configuration of this type of the latching height results in an increased freedom of movement and, in addition, a certain freedom of movement and flexibility during assembly and during the introduction of the screw, improved flexibility during the assembly and during the introduction of the screw. The latching height E should advantageously be kept as small as possible, per an embodiment, in comparison with the sheet metal thickness (material thickness), in order thus to counteract the spring clip falling out of the opening.

It is preferably provided, per an embodiment, that the spring clip comprises at least one, in particular at least two retaining brackets for securing the threaded nut against rotation. It is conceivable in accordance with one development that the retaining brackets are each arranged on one side of the bottom, on which no limb is arranged. Moreover, the retaining brackets should extend, in particular, perpendicularly from the bottom, with the result that they configure, with the limbs, an at least partially closed receptacle for the threaded nut. A configuration of this type has the advantage, per an embodiment, that the threaded nut cannot be separated from the spring clip in a direction which runs perpendicularly or transversely with respect to the introduction direction of the spring clip or with respect to the screw-in direction of the tensioning screw. Rather, the threaded nut is molded or encased into the spring clip and is therefore held captively in the receptacle of the spring clip. Furthermore, in addition to the limbs, the retaining brackets can absorb a possibly occurring torque which can arise when the tensioning screw is screwed into the threaded nut. They therefore likewise serve as an anti-rotation safeguard of the threaded nut.

It can be provided, moreover, that the spring clip comprising bottom, limbs and retaining brackets is configured in one piece. Here, a very wide variety of materials can be used. The spring clip can be produced, for example, from a metal. An embodiment which comprises a material made from plastic is also conceivable, however. It is possible, moreover, that the spring clip is produced from a different material than the tensioning element and/or the threaded nut. A material combination of two or more sheet metal types (for example, a bimetal) is also conceivable. It is also possible for metal sheets with different thicknesses to be provided.

The latching connection between the spring clip and the tensioning element permits almost any desired combination of materials.

The edges of the spring clip are advantageously configured as open edges, per an embodiment. In other words: the retaining brackets are not connected to the limbs, apart from via the bottom. Instead, the receptacle of the spring clip is open in the region of its edges, with the result that the corners of the threaded nut protrude out of the receptacle of the spring clip there. As a result, the spring clip can be manufactured with relatively high tolerances, which makes simple production by means of a bending process possible.

It can be provided in accordance with one development that the first kink defines a first interior angle β, β′, that the second kink defines a second interior angle γ, γ′, and that the third kink defines a third interior angle δ, δ′ The first interior angle β, β′ and the second interior angle γ, γ′ can each be obtuse (that is to say, 90° or greater) or acute (that is to say, less than) 90°. The third interior angle δ, δ′ is preferably in each case smaller than 90°, in particular is smaller than 60°.

A further aspect of the disclosure, per an embodiment, relates to a threaded nut arrangement for bracing a tensioning clamp, comprising a spring clip in accordance with one of the preceding embodiments and a threaded nut which interacts with a tensioning screw, it being possible for the threaded nut to be arranged in the spring clip such that it cannot rotate in the case of use as intended.

A further aspect of the disclosure, per an embodiment, relates to a tensioning clamp with a tensioning screw which interacts with a polygonal threaded nut, the tensioning clamp comprising a threaded nut arrangement in accordance with one of the preceding embodiments.

### BRIEF DESCRIPTION OF THE FIGURES

Further features, details and advantages of the disclosure result from the wording of the claims and from the following description of exemplary embodiments on the basis of the drawings, in which:

FIG. 1 shows a spring clip in accordance with one embodiment in a first diagrammatic side view,

FIG. 2 shows the spring clip according to FIG. 1 in a second diagrammatic side view,

FIG. 3 shows a threaded nut arrangement comprising the spring clip according to FIG. 1 and a threaded nut in a first diagrammatic side view,

FIG. 4 shows the threaded nut arrangement according to FIG. 3 in a second diagrammatic side view.

### DETAILED DESCRIPTION

In the figures, identical or corresponding elements are each denoted by way of the same designations and are therefore not described again unless expedient. Features which have already been described are not described again in order to avoid repetitions, and can be applied to all elements with identical or corresponding designations, unless ruled out explicitly. The disclosures contained in the entire description can be transferred mutatis mutandis to identical parts with identical designations or identical component terms. The positional specifications selected in the description such as, for example, top, bottom, side, etc. also relate to the directly described and shown figure and, in the case of a positional change, can be transferred mutatis mutandis to the new position. Furthermore, individual features or combinations of features from the illustrated and described different exemplary embodiments can also per se represent solutions which are independent, inventive or according to the invention. Within the context of this application, the terms “cage nut arrangement” and “threaded nut arrangement” are used interchangeably as long as nothing else results from the respective context. The terms are essentially to be understood to mean an arrangement which comprises a cage or a spring clip and a threaded nut received therein. Accordingly, the terms “cage nut” and “threaded nut” are also used interchangeably as long as nothing else results from the respective context.

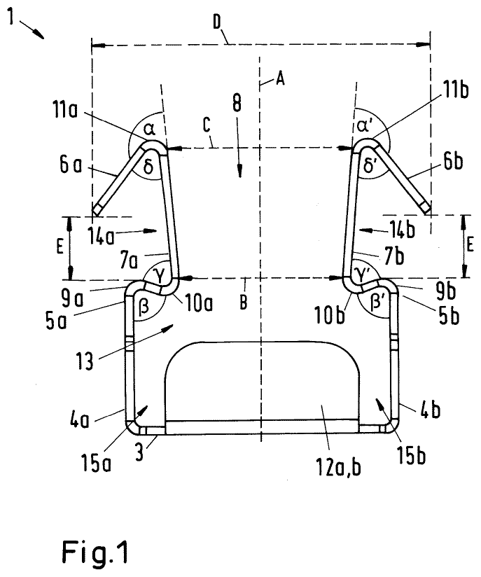

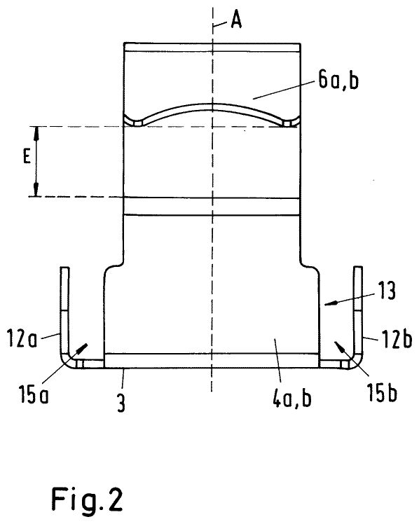

FIG. 1 shows a first diagrammatic side view of a spring clip 1 for receiving a polygonal threaded nut in accordance with one embodiment such that it cannot rotate. FIG. 2 shows the spring clip 1 from FIG. 1 in a second diagrammatic side view. The description of the embodiment shown in FIG. 1 therefore also applies to the embodiment of FIG. 2.

The U-shaped configuration of the spring clip 1 can be seen in the side view selected for FIG. 1. The spring clip 1 shown by way of example has a bottom 3 and two limbs 4a,b. Here, each limb 4a,b comprises an inwardly (that is to say, toward the vertical center axis A of the spring clip) directed step 5a,b and an outwardly (that is to say, away from the vertical center axis A of the spring clip) directed free end 6a,b. The portion of the limb 4a,b between the step 5a,b and the free end 6a,b of in each case one limb 4a,b is configured as a latching portion 7a,b.

As shown in FIG. 1, the free ends 6a,b of the spring clip 1 are bent away from one another in such a way that they configure a tip. They therefore have an exterior angle α, α′ of approximately 135° relative to the latching portion 7a,b of the respective limb 4a,b. The free ends 6a,b are correspondingly kinked in such a way that they each define an interior angle δ, δ′ of approximately 45°.

It is provided here that the exterior angles α, α′ and the interior angles δ, δ′ of the free ends 6a,b are each complementary to form 180°, that is to say the exterior angle α and the interior angle δ together result in 180°, and the exterior angle α′ and the interior angle δ′ likewise together result in 180°. By way of a configuration of this type, it is possible in a simple way for the spring clip 1 and therefore the threaded nut arrangement to be introduced into and latched in a corresponding opening in the tensioning head of a tensioning clamp. Finally, the maximum width C of the spring clip 1 can be kept relatively small by way of the acutely outwardly bent free ends 6a,b. During the introduction of the spring clip 1 into the opening, the free ends 6a,b are pressed inward in the direction of the latching portions 7a,b—the exterior angles α, α′ therefore become greater and the interior angles δ, δ′ become smaller. At the same time, the limbs 4a,b are moved slightly toward one another during the introduction of the spring clip 1. As soon as the free ends 6a,b have passed the opening of the tensioning head, the limbs 4a,b spring back into their starting state again. The free ends then prevent the spring clip from slipping out.

In accordance with the example shown in FIG. 1, the latching portions 7a,b of the limbs 4a,b are each of inclined configuration with respect to a center axis A which runs perpendicularly with respect to the bottom 3. Here, the latching portions 7a,b are inclined, in particular, with respect to the center axis A in such a way that a passage 8 which is configured between the latching portions 7a,b tapers in the direction of the bottom 3. The slope or inclination of the latching portions 7a,b contributes to it being possible for the threaded nuts 2 to be introduced in a simple way into the receptacle 13 of the spring clip 1 after production of the spring clip 1.

As shown in FIG. 1, the limbs 4a,b each preferably comprise a first kink 9a,b, a second kink 10a,b and a third kink 11a,b. Here, the first kink 9a,b and the second kink 10a,b configure the inwardly directed step 5a,b of the limb 4a,b. The third kink 11a,b is configured at the transition from the latching portion 7a,b to the free end 6a,b of in each case one of the limbs 4a,b. By way of the kinks 9a,b, 11a,b, 12a,b, the pivoting capability of the limbs 4a,b is increased in comparison with the limbs without a kink. It is provided here that there is a spacing B between the second kinks 10a,b of the two limbs 4a,b, which spacing B is smaller than a spacing C between the third kinks 11a,b of the two limbs 4a,b. This embodiment results from the funnel shape of the passage 8 of the spring clip 1. As a result, the guidance of the threaded nut 2 into the spring clip 1 is additionally facilitated.

In accordance with the example which is shown in FIG. 1, the first kink 9a,b, the second kink 10a,b and the third kink 11a,b are each of acute configuration, that is to say they each comprise interior angles which are smaller than 90°. Here, the first kink 9a,b defines an interior angle β, β′, the second kink 10a,b defines a second interior angle γ, γ′, and the third kink 11a,b defines a third interior angle δ, δ′.

The embodiment which is shown in FIG. 1 comprises, in each case in the region of the latching portions 7a,b, a latching groove 14a,b which is configured to interact with the opening of the tensioning element. Here, the latching groove 14a,b is intended to interact with the inner edge of the opening, with the result that the spring clip 1 and therefore the threaded nut 2 can be held captively on the tensioning element. Here, the latching groove 14a,b can have an extent which is such that the spring clip 1 can be latched pivotably to the tensioning element. It is advantageous here that the latching groove 14a,b has a variable latching height E as a result of the outwardly and downwardly curved arrow-shaped free ends 6a,b. Here, the latching height E is to be understood to be the spacing between the free end 6a,b and the first kink 9a,b of in each case one limb 4a,b. As a result of this special configuration, the free ends 6a,b have a spring force, by way of which it is made possible that the latching groove 14a,b can reliably grip tensioning heads with different material thicknesses.

It can be seen in FIG. 1 and FIG. 2, moreover, that the spring clip 1 can comprise at least two retaining brackets 12a,b for securing the threaded nut 2 against rotation. Here, in each case one of the retaining brackets 12a,b is arranged on in each case one side of the bottom 3, on which side no limb 4a,b is arranged. As shown in FIG. 2, the retaining brackets 12a,b preferably extend perpendicularly from the base 3 in such a way that, with the limbs 4a,b, they configure an at least partially closed receptacle 13 for the threaded nut 2. A configuration of this type has the advantage that the threaded nut 2 can be held captively in the spring clip 1. Moreover, in addition to the limbs 4a,b, the retaining brackets 12a,b can absorb a torque which can occur during screwing of the tensioning screw into the threaded nut 2.

As is shown in FIGS. 1 and 2, moreover, the edges of the spring clip 1 are configured as open edges 15a,b, with the result that the corners of the threaded nut 2 protrude out of the receptacle 13 of the spring clip 1. As a result, the spring clip 1 can be manufactured with relatively high tolerances, which makes simple production by means of a bending process possible.

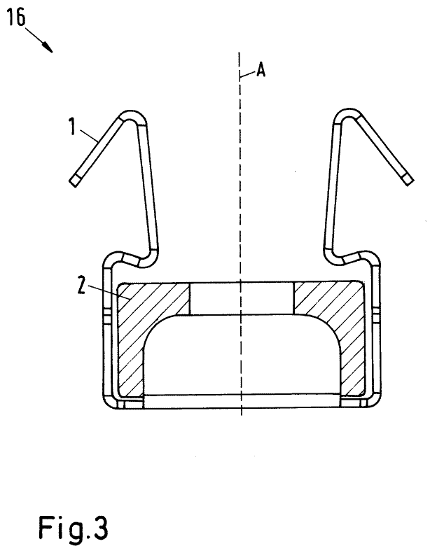

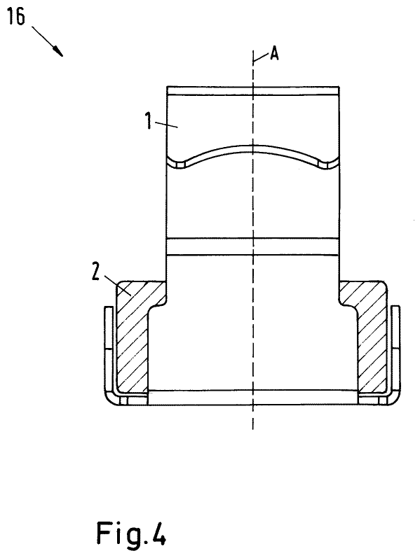

FIG. 3 and FIG. 4 each show a threaded nut arrangement 16 which comprises the spring clip 1 according to FIG. 1 and FIG. 2 and a polygonal threaded nut 2 which is arranged therein. Here, the threaded nut 2 is enclosed captively in the receptacle 13 of the spring clip 1.

The invention is not restricted to one of the above-described embodiments, but rather can be modified in a variety of ways.

All of the features and advantages which are apparent from the claims, the description and the drawing, including structural details, spatial arrangements and method steps, can be essential to the invention both per se and in a very wide variety of combinations.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

1 Spring clip
2 Threaded nut
3 Bottom
4a,b Limb
5a,b Step
6a,b Free end
7a,b Latching portion
8 Passage
9a,b First kink
10a,b Second kink
11a,b Third kink
12a,b Retaining bracket
13 Receptacle
14a,b Latching groove
15a,b Open edges
16 Threaded nut arrangement
α, α′ Exterior angle
β, β′ First interior angle
γ, γ′ Second interior angle
δ, δ′ Third interior angle
A Center axis
B First spacing
C Second spacing
D Width
E Latching height

1. A spring clip for receiving a polygonal threaded nut such that it the polygonal threaded nut cannot rotate, the spring clip being of substantially U-shaped configuration and having a bottom and two limbs, each limb having at least one step and a free end, a latching portion being configured between the step and the free end of in each case one limb, and the free ends of the limbs being bent away from one another in each case, wherein the bent free ends are at an exterior angle (α,α′) of more than 100° relative to the latching portion.

2. The spring clip as claimed in claim 1, wherein the latching portions of the limbs are of inclined configuration in each case with respect to a center axis (A) which runs perpendicularly with respect to the bottom.

3. The spring clip as claimed in claim 2, wherein the latching portions are of inclined configuration with respect to the center axis (A) in such a way that a passage which is configured between the latching portions tapers in the direction of the bottom.

4. The spring clip as claimed in claim 1, wherein the limbs each comprise a first kink, a second kink and a third kink, the first kink and the second kink configuring the step of in each case one of the limbs, and the third kink being configured at the transition from the latching portion to the free end of in each case one of the limbs.

5. The spring clip as claimed in claim 4, wherein a spacing (B) between the second kinks of the limbs is smaller than a spacing (C) between the third kinks of the limbs.

6. The spring clip as claimed in claim 4, wherein the free ends are bent away from one another in such a way that they are each bent in the region of the third kink by an exterior angle (α, α′) of of more than 80° relative to the latching portion.

7. The spring clip as claimed in claim 1, wherein the spring clip comprises at least two retaining brackets for securing the threaded nut against rotation.

8. The spring clip as claimed in claim 7, wherein the retaining brackets are each arranged on one side of the bottom and extend perpendicularly from the bottom in such a way that they configure an at least partially closed receptacle for the threaded nut with the limbs.

9. The spring clip as claimed in claim 1, wherein the spring clip comprising bottom, limbs and retaining brackets is configured in one piece.

10. The spring clip as claimed in claim 1, wherein the limbs comprise, in each case in the region of the latching portion, a latching groove which is configured to interact with an opening of a clamping element.

11. The spring clip as claimed in claim 4, wherein the first kink defines a first interior angle (β, β′), in that the second kink defines a second interior angle (γ, γ′), and in that the third kink defines a third interior angle (δ, δ′), the first interior angle (β, β′), the second interior angle (γ, γ′) and the third interior angle (δ, δ′) each being smaller than 90°.

12. A threaded nut arrangement for bracing a tensioning clamp, comprising a spring clip as claimed in claim 1 and a threaded nut which can interact with a tensioning screw, it being possible for the threaded nut to be arranged in the spring clip such that it cannot rotate in the case of use as intended.

13. A tensioning clamp with a tensioning screw which interacts with a polygonal threaded nut, the tensioning clamp comprising a threaded nut arrangement as claimed in claim 11.
